(19) United States
(12) Patent Application Publication
(10) Pub. No.: US 2004/0145558 A1
(43) Pub. Date: Jul. 29, 2004

(54) Control device for dynamically adjusting backlight brightness and color of computer display

(76) Inventor: Wen-Yen Cheng, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/458,679

(22) Filed: Jun. 11, 2003

(30) Foreign Application Priority Data
Jan. 29, 2003 (TW) 92201715

(51) Int. Cl. G09G 3/36

(52) U.S. Cl. 345/102

(57) ABSTRACT

A control device for dynamically controlling brightness of backlight and displayed color of a liquid crystal display of a computer system, such as a notebook computer, includes a dynamic display control device comprised of a micro-controller coupled to the computer and an environmental brightness detector coupled to the micro-controller for detecting brightness of surrounding light and generating an environmental brightness signal to the micro-controller. Based on the environmental brightness signal, the dynamic display control device generates a backlight brightness control signal to a backlight plate of the liquid crystal display to set the backlight brightness of the display. The device further includes a color matrix plate comprised of a number of light emitting diodes for selectively emitting lights of different colors. The micro-controller selectively generates a plurality of color control signals, respectively associated with RED, GREEN, BLUE and YELLOW colors, applied to the display for controlling the displayed color of the computer display.

### BACKGROUND OF THE INVENTION

1. Field of the Invention

The present invention relates generally to a control device for a computer display, such as a liquid crystal display, and in particular to a control device capable of automatically and dynamically adjusting the backlight brightness and displayed colors of the display.

2. Description of the Prior Art

Computer displays are one of the most important output devices of computer systems. A computer operator can monitor the operation of the computer and properly issue instruction to computer based on the information displayed on the display. Two major displays are currently available in the market, namely cathode ray tube based display and liquid crystal display. The later is advantageous in reduced power consumption, light weight and small size. Also the liquid crystal display generates no harmful radiation to viewer's eyes. Thus, the liquid crystal display is playing an increasingly important role in computer output and gradually replaces the cathode ray tube display.

FIG. 1 of the attached drawings shows a block diagram of a conventional computer system, generally designated with reference numeral 1, comprising a central processing unit 10, a system bus 11 connecting a random access memory 13, a read only memory 14 and a bridge 15 to the central processing unit 10, a PCI/ISA bus 12 connecting a keyboard 16, a data storage 17 and a liquid crystal display 19 to the bridge 12. The liquid crystal display 19 is coupled to the PCI/ISA bus 12 via a display interface 18. Currently, the display interface 18 for personal computers, such as desktop computers and notebook computers, are of color interface. The liquid crystal display 19 receives color image signals from the interface 18 and displays the image in colorful form on the display 19.

A liquid crystal display requires backlight for proper display of the colorful images. Conventionally, the liquid crystal display is provided with a backlight of fixed brightness. Alternatively, manual adjustment of the backlight brightness is provided by means of a manually adjusted variable resistor. The variable resistor allows for application of voltages of different levels to the liquid crystal display for control of the backlight brightness. Adjusting the backlight brightness with digital means is also known.

The conventional measure for adjusting backlight brightness is performed manually. For example, a computer user may manually increase the backlight brightness in a bright environment. This is troublesome for computer systems that are constantly moved between different environments, such as notebook computer, for the user has to repeatedly adjust the backlight brightness to fit the surrounding brightness.

Further, the brightness for different colors displayed on the computer display is in general fixed, which does not allow a computer user to easily modify by himself or herself. Although computer displays that allow for manual adjustment of the brightness for colors displayed are known, such adjustment is again performed manually through control programs. This leads to certain problems to the regular users who may not have skills in performing such adjustment and it is troublesome to execute the control program each time the brightness of color displayed is to be changed.

### SUMMARY OF THE INVENTION

Thus, an object of the present invention is to provide a dynamic backlight brightness control device, which automatically and dynamically adjust the brightness of backlight of a computer display, such as a liquid crystal display, based on the brightness of the surrounding light.

Another object of the present invention is to provide a control device for computer display that allows for adjustment of color displayed on the computer display so as to fit personal preference of each particular computer user.

To achieve the above objects, in accordance with the present invention, there is provided a dynamic display control device for adjusting backlight brightness of a computer display, comprising a micro-controller coupled to a computer by a bus and an environmental brightness detector that detects the brightness of surrounding light or an external light source. The micro-controller of the control device receives an environmental brightness signal from the detector and, in response thereto, generates a backlight brightness control signal to a backlight plate of the computer display for changing the brightness of the backlight given off by the backlight plate. Further, color control signals are selectively issued by the control device to the display for changing the color displayed on the display.

The control device may comprise a keyboard controller of the computer. Firmware pre-established in the keyboard controller may function to detect the brightness of the surrounding light for changing the brightness of the backlight emitted by the backlight plate. By means of particular keys of the computer keyboard, the keyboard controller also allows for issuance of color control signals, which allow a computer user to change the colors displayed on the display based on his or her preference.

### BRIEF DESCRIPTION OF THE DRAWINGS

The present invention will be apparent to those skilled in the art by reading the following description of a preferred embodiment thereof, with reference to the attached drawings, in which:

FIG. 1 is a system block diagram of a conventional computer system;

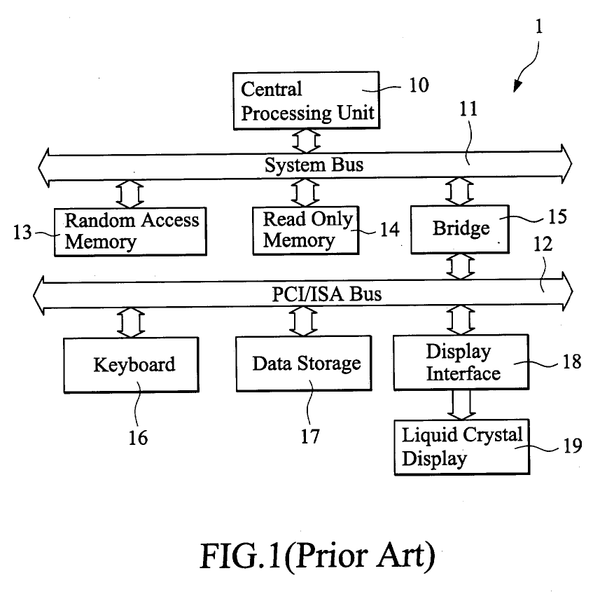

FIG. 2 is system block diagram of a computer system in which a dynamic control device in accordance with the present invention is incorporated; and

FIG. 3 is a block diagram of the dynamic control device of the present invention, which also shows a connection between the dynamic display control device and the liquid crystal display.

### DETAILED DESCRIPTION OF PREFERRED EMBODIMENT

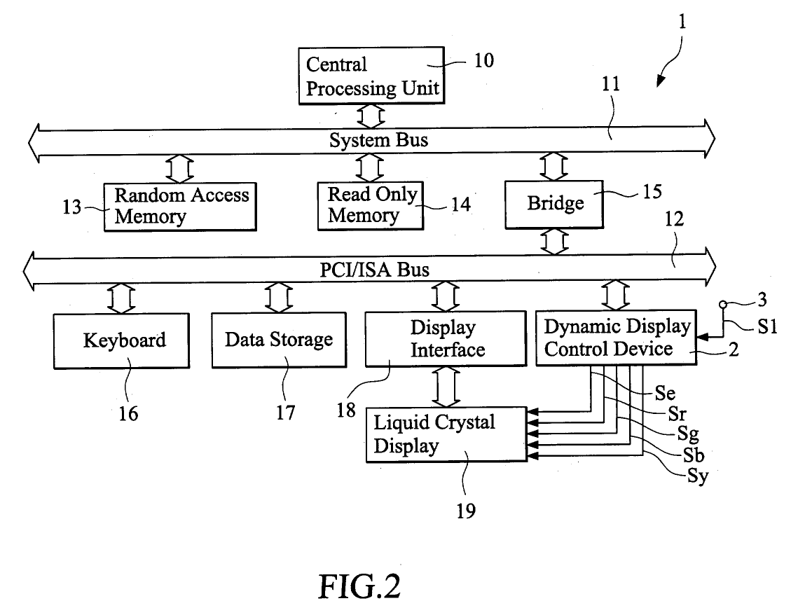

With reference to the drawings and in particular to FIG. 2, a computer system 1 comprises a central processing unit 10, a system bus 11, a PCI/ISA bus 12, a random access memory 13, a read only memory 14, a bridge 15, a keyboard 16, and a data storage 17. The computer system 1 further comprises a display interface 18, which is often a color display interface connected to the PSCI/ISA bus 12 of the computer system 1. A display 19, such as a liquid crystal display, is coupled to the display interface 18 for receiving and displaying image signals transmitted from the computer system 1.

The display interface 18 generally comprises a display memory, an image mapping register and a digital to analog converter. The image signal generated by the computer system 1 is transferred to the display memory via data bus of the PCI/ISA bus 12 and then processed by the image mapping register and the digital to analog converter to provide R, G, B signals in analog form to the liquid crystal display 19.

In accordance with the present invention, a dynamic display control device 2 is coupled to the PCI/ISA bus 12 of the computer system 1. The dynamic display control device 2 comprises an environmental brightness detector 3 for detecting the brightness of the surrounding light in which the computer system 1 is operated and generating an environmental brightness signal S1 to the dynamic display control device 2. Based on the environmental brightness signal S1, the dynamic display control device 2 issues a backlight brightness control signal Se to the liquid crystal display 19 for controlling the backlight brightness of the liquid crystal display 19.

The control device 2 also provides RED background color control signal Sr, GREEN background color control signal Sg, BLUE background color control signal Sb and YELLOW background color control signal Sy to the liquid crystal display 19 for controlling the color displayed on the liquid crystal display 19.

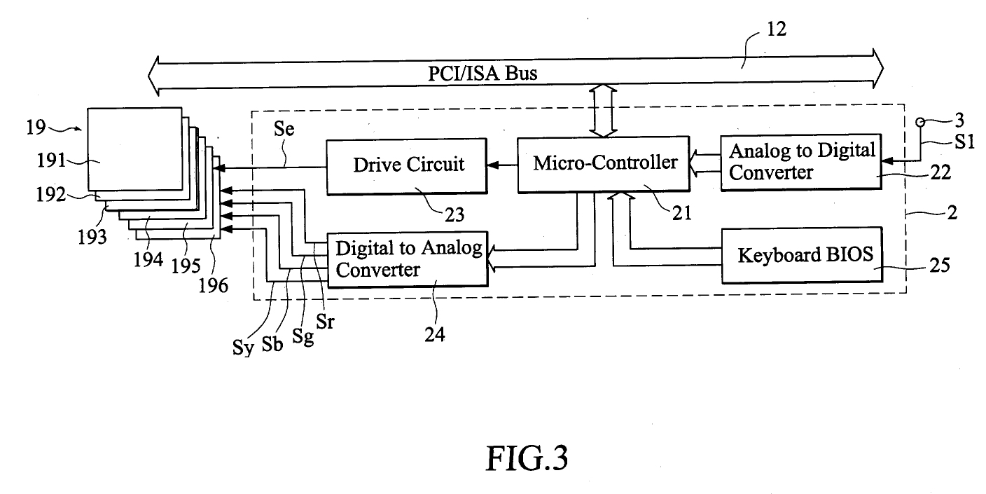

Also referring to FIG. 3, it is a block diagram of the dynamic control device of the present invention, showing a connection between the dynamic display control device 2 of the present invention and the liquid crystal display 19. The liquid crystal display 19 comprises a protective shielding plate 191, a horizontal polarization plate 192, a liquid crystal layer 193, a vertical polarization plate 194 and a backlight plate 195. By providing voltages of different levels to the backlight plate 195, the brightness of the backlight emitted by the liquid crystal display 19 is changed.

The dynamic display control device 2 comprises a micro-controller 21 that is connected to the PCI/ISA bus 12 of the computer system 1. The environmental brightness detector 3 is coupled to the micro-controller 21 by an analog to digital converter 22 to apply the environmental brightness signal S1, which represents the brightness of the surrounding light in which the computer system 1 is operated, to the micro-controller 22. An example of the environmental brightness detector 3 comprises a photo-sensitive resistor or other electronic devices capable of detection of light.

The micro-controller 21 of the dynamic display control device 2 receives and processes the environmental brightness signal S1 and generates a voltage output having a voltage level determined by calculation performed by the micro-controller 21 according to pre-established algorithm. The voltage output is applied to a drive circuit 23, which in turn provides the backlight brightness control signal Se to the backlight plate 195 of the liquid crystal display 19. The backlight brightness of the liquid crystal display 19 can thus be controlled by providing different voltage levels to the backlight plate 195 by the drive circuit 23.

Further, the liquid crystal display 19 comprises a color matrix plate 196 comprised of for example an array of light emitting diodes (LED) of different colors. The LED array that comprises LEDs of different colors allows for emission of light of different colors by the liquid crystal display 19. Thus, backlight of different colors is can be provided.

In an embodiment of the present invention, the micro-controller 21 provides color control related signals based on the environmental brightness signal S1. These signals that may be different are processed by a digital to analog converter 24 to generate the RED background color control signal Sr, GREEN background color control signal Sg, BLUE background color control signal Sb and YELLOW background color control signal Sy. Such background color control signals Sr, Sg, Sb and Sy are applied to the color matrix plate 196 of the liquid crystal display 19 to control the colors displayed on the liquid crystal display 19.

In an embodiment of the present invention, in the application of notebook computers, the micro-controller 21 comprises an embeded keyboard controller of the notebook computer. The keyboard controller comprises a keyboard BIOS 25 comprised of firmware capable of reading the environmental brightness signal S1 and in response thereto, generates the backlight brightness control signal Se to the backlight plate 195 of the liquid crystal display 19 to change the brightness of the backlight of the liquid crystal display 19.

Further, the keyboard controller of the notebook computers may be configured to allow an operator to issue, by means of pre-selected keys of the keyboard, the RED background color control signal Sr, GREEN background color control signal Sg, BLUE background color control signal Sb and YELLOW background color control signal Sy to the liquid crystal display 19 for changing the color displayed on the liquid crystal display 19. Thus, the operator is allowed to adjust the display color of the liquid crystal display 19 based on personal preference or in accordance with difference between computer systems.

By means of the invention described above, the computer display can automatically adjust the backlight brightness thereof in accordance with the brightness of surrounding light and allows for change or modification of the displayed color to shows the preferred display color for the users.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A control device for dynamically controlling a brightness of a backlight and displayed color of a computer display of a computer system comprising:
a dynamic display control device comprising a micro-controller coupled to the computer system by a bus;
an environmental brightness detector coupled to the micro-controller for detecting brightness of surrounding light and generating an environmental brightness signal to the micro-controller; and
a color matrix plate comprising a plurality of light sources and attached to a backlight plate of the computer display;
wherein the micro-controller of the dynamic control device receives the environmental brightness signal generated by the environmental brightness detector and generates a backlight brightness control signal to the backlight plate of the computer display to set brightness of backlight of the computer display and a plurality of color control signals applied to the color matrix plate to control the displayed color of the computer display.

2. The control device as claimed in claim 1, wherein the color matrix plate comprises a plurality of light emitting diodes of different colors to provide different colors to the computer display.

3. The control device as claimed in claim 2, wherein the color control signal comprises a RED background color control signal, a GREEN background color control signal, a BLUE background color control signal and a YELLOW background color control signal.

4. The control device as claimed in claim 1, wherein the dynamic display control device comprises a keyboard controller of the computer.

5. The control device as claimed in claim 1, wherein the environmental brightness detector comprises a photo-sensitive resistor.
